(19) United States
(12) Patent Application Publication
(10) Pub. No.: US 2019/0168336 A1
(43) Pub. Date: Jun. 6, 2019

(54) FRICTION WELDING PROCESS

(71) Applicant: ROLLS-ROYCE plc, London (GB)

(72) Inventors: Simon E. Bray, Derby (GB); Andrew R. Walpole, Derby (GB); Robin Wilson, Derby (GB)

(21) Appl. No.: 16/252,136

(22) Filed: Jan. 18, 2019

Related U.S. Application Data
(62) Division of application No. 15/685,081, filed on Aug. 24, 2017.

(30) Foreign Application Priority Data
Aug. 26, 2016 (GB) 1614566.6

(51) Int. Cl. B23K 20/12; B23K 33/00

(52) U.S. Cl. CPC B23K 20/1205; B23K 20/129; B23K 2101/001; B23K 33/00; B23K 20/12

(57) ABSTRACT

A workpiece for use with a friction welding process comprises a weld surface. The weld surface comprises a central ridge surface extending along the weld surface, with the central ridge surface being flanked on either side respectively by a first pyramidal surface and a second pyramidal surface. The first pyramidal surface subtends a first pyramidal angle with the central ridge surface, and the second pyramidal surface subtends a second pyramidal angle with the central ridge surface. The first pyramidal surface is further flanked by a third pyramidal surface, and the second pyramidal surface is further flanked by a fourth pyramidal surface, with the third pyramidal surface subtending a third pyramidal angle with the central ridge surface, and the fourth pyramidal surface subtending a fourth pyramidal angle with the central ridge surface. Each of the third pyramidal angle and the fourth pyramidal angle is less than 90°.

This application is based upon and claims the benefit of priority from British Patent Application Number 1614566.6 filed 26 Aug. 2016, the entire contents of which are incorporated by reference.

### FIELD OF THE DISCLOSURE

The present disclosure relates to a friction welding process and particularly, but not exclusively, to a linear friction welding process, together with a weld stub geometry for use with the method.

### BACKGROUND TO THE DISCLOSURE

Linear friction welding (LFW) is a solid state welding process for joining regular and irregular sections of metallic or non-metallic materials either welded to themselves or each other.

Welds are produced by linear oscillation, at a given frequency, of one part against the other while the parts are pressed together by a forge force applied to the interface.

During the LFW process, the components are locally heated at the contact zone by the friction force resulting from the combination of relative oscillatory motion and the forge force. As the temperature at the contact zone increases, the material becomes highly plastic, and flash is extruded from the weld zone under the action of the oscillatory motion and the forge force.

The continued application of the forge force during the LFW process causes the components to become closer together in a direction normal to that of the oscillatory motion. This length reduction occurs as long as the component material behaves in a plastic manner.

When the components have reached the desired length reduction (known as the burn-off distance) the oscillation amplitude is ramped-down to zero, and the parts are hot-forged together by the forge force for a predetermined time whilst the weld cools.

In a conventional LFW process, the components are formed with planar weld joint surfaces. This arrangement has been shown to retain contaminants in the weld joint even after appreciable burn-off, as shown in FIG. 1. In the prior art arrangement of FIG. 1, the weld stubs 1,2 have a weld interface 6. The centre-line of the weld interface is indicated as 4. As the weld stubs 1,2 are forced together during the LFW process material is ejected from the joint as flash 3. The centre-line 4 down the length of the material approximately divides the regions where material is ejected to the right and left of the joint.

Any contaminants 5 sitting on or close to the centre-line 4 may not be ejected from the weld between stubs 1 and 2 and are therefore not extruded into the flash 3 and instead remain in the weld joint. These retained contaminants may compromise the weld integrity.

Edge breakaway is a welding feature characterised by deformation of the edge of the LFW stub such that a large cold chunk of parent material breaks off releasing local constraint to plastic flow and allowing material to be preferentially drawn across the weld. This potentially compromises weld integrity by exposing the full weld joint to atmospheric contamination formed at the weld interface during heating, for example by forming hard alpha particles in titanium alloys.

Deformation of the edge of the LFW stub can compromise optimum conditions for the extrusion and ejection of contamination from the weld. In extreme circumstances, the deformed stub corners may detach, further compromising optimum material flow conditions. This deformation and detachment of the stub corners may occur symmetrically or asymmetrically.

FIGS. 2A to 2C illustrates a schematic progression of a typical LFW process showing how deformation or detachment of the stub corners occurs when one of the weld stubs 1 is provided with an angled face geometry 10. This tapering region at the weld interface expels contaminants from the interface 6 by changing the flow regime from that which would be expected by the use of planar surfaces. This can prevent the inclusion of contaminants in the weld interface 6 by generating an increased quantity of flash 3. However, as the angled face stub 1 digs into the opposing flat faced stub 2 (shown in FIG. 2B), some of the material from the weld interface 6 is deformed at the edges 12,14 of the weld interface 6.

As the LFW process progresses, this deformed material 12,14 detaches from the weld stub 2 and is ejected into the flash 16,18.

The conditions that lead to deformation and detachment of the stub corners may be exacerbated by welding two workpieces of dissimilar alloy materials.

### SUMMARY

According to a first aspect of the present disclosure there is provided a workpiece for use with a friction welding process, the workpiece comprising a weld surface,
wherein the weld surface comprises a central ridge surface extending along the weld surface, the central ridge surface being flanked on either side respectively by a first pyramidal surface and a second pyramidal surface, the first pyramidal surface subtending a first pyramidal angle with the central ridge surface, and the second pyramidal surface subtending a second pyramidal angle with the central ridge surface, the first pyramidal surface being further flanked by a third pyramidal surface, and the second pyramidal surface being further flanked by a fourth pyramidal surface, the third pyramidal surface subtending a third pyramidal angle with the central ridge surface, and the fourth pyramidal surface subtending a fourth pyramidal angle with the central ridge surface, and each of the third pyramidal angle and the fourth pyramidal angle being less than 90°.

By providing the weld surface with the combination of first and second pyramidal surfaces, and third and fourth pyramidal surfaces, the workpiece can be subjected to an LFW process and the resulting welded joint does not have trapped contaminants at a centre region of the joint, and also the welded joint does not suffer from deformation and detachment at the edges of the joint.

The double pyramidal geometry of the weld stub prevents the generation of material deformation and detachment by providing additional lateral support to the edges of the weld interface. This additional support prevents the material ejected from the weld interface from deforming and detaching from the weld stub.

Optionally, the first pyramidal angle is equal to the second pyramidal angle.

Making the first pyramidal angle equal to the second pyramidal angle provides for a symmetrical sectional geometry for the portion of the workpiece that is closest to the contact zone. This ensures that weld material is ejected symmetrically from the contact zone during the weld process.

Optionally, the third pyramidal angle is equal to the fourth pyramidal angle.

Making the third pyramidal angle equal to the fourth pyramidal angle provides for a symmetrical sectional geometry for the portion of the workpiece that is furthest from the contact zone. This ensures that weld material is ejected symmetrically from the contact zone and the welded joint does not suffer from deformation and detachment at edges of the joint.

Optionally, the central ridge surface has a lateral width of between approximately 1 mm and 5 mm.

Keeping the lateral width of the central ridge less than 5 mm more effectively provides for the ejection of surface contaminants from the weld zone. However, in alternative arrangements of the disclosure the central ridge surface may have a lateral width of up to approximately 9 mm.

Optionally, each of the first pyramidal angle and the second pyramidal angle is between approximately 6° and 12°.

Keeping the first pyramidal angle and the second pyramidal angle within the range of approximately 6° and 12° provides a balance between ensuring the elimination of surface contaminants from the weld zone, and minimising the volume of material that must be ejected from the joint as flash during the weld process.

Optionally, each of the first pyramidal angle and the second pyramidal angle is between approximately 6° and 30°.

Keeping the first pyramidal angle and the second pyramidal angle within the range of approximately 6° and 30° provides a balance between ensuring the elimination of surface contaminants from the weld zone, and minimising the volume of material that must be ejected from the joint as flash during the weld process.

Optionally, each of the third pyramidal angle and the fourth pyramidal angle is between approximately 30° and 65°.

The selection of the third pyramidal angle and the fourth pyramidal angle as being between approximately 30° and 65° ensures that there is sufficient mechanical support at the stub corners to avoid deformation and detachment conditions from developing

Optionally, each of the third pyramidal angle and the fourth pyramidal angle is between approximately 30° and 90°.

The selection of the third pyramidal angle and the fourth pyramidal angle as being greater than 65° and less than approximately 90° provides a balance between additional mechanical support at the stub corners to minimise deformation and detachment conditions from developing, and minimising the addition of material to the workpiece, which subsequently may have to be machined away after the friction welding process.

Optionally, the weld surface is curvilinear.

When using the LFW process to join blades to a disc, for example to form a bladed disk, the weld surface is curvilinear.

Optionally, the workpiece is formed from titanium or nickel alloys.

The process of deformation and detachment can expose the weld joint to atmospheric contamination formed at the weld interface during heating and compromise optimum conditions for the extrusion and ejection of contamination from the weld joint. A particular example of this being the formation of hard alpha particles in titanium alloys.

According to a second aspect of the present disclosure there is provided a method of linear friction welding, the method comprising the steps of:
providing a first workpiece and a second workpiece, the first workpiece comprising a first weld surface, and the second workpiece comprising a second weld surface, and at least one of the first workpiece and the second workpiece comprising a workpiece according to the first aspect;
positioning the first workpiece adjacent to the second workpiece, with the first weld surface being in engagement with the second weld surface;
reciprocating the first workpiece and the second workpiece against one another such that at least one of the first weld surface and the second weld surface moves relative to the other of the first weld surface and the second weld surface, such that a temperature at the first and second weld surfaces increases to create a weld interface; and
stopping the reciprocating and allowing the first workpiece and the second workpiece to cool to weld the first workpiece and the second workpiece together.

However, when a pyramidal geometry is used for one of the weld stubs then the problem of deformation and detachment has been shown to occur.

By providing the weld surface with the combination of first and second pyramidal surfaces, and third and fourth pyramidal surfaces, the workpiece can be subjected to an LFW process and the resulting welded joint does not have trapped contaminants at a centre region of the joint, and also the welded joint does not suffer from deformation and detachment at edges of the joint.

Optionally, the step of providing a first workpiece and a second workpiece, the first workpiece comprising a first weld surface, and the second workpiece comprising a second weld surface, and at least one of the first workpiece and the second workpiece comprising a workpiece according to the first aspect, comprises the step of:
providing a first workpiece and a second workpiece, the first workpiece comprising a first weld surface, and the second workpiece comprising a second weld surface, and each of the first workpiece and the second workpiece comprising a workpiece according to the first aspect.

In an alternative embodiment of the method each of the first workpiece and the second workpiece comprises respectively a first weld surface and a second weld surface, and each of the first weld surface and the second weld surface has a double pyramidal geometry according to the first aspect of the disclosure.

Optionally, the first workpiece is formed from a first material having a first strength parameter, and the second workpiece is formed from a material having a second strength parameter, and a first ratio is defined between the first pyramidal angle of the first workpiece and a corresponding one of the first pyramidal angle and second pyramidal angle of the second workpiece, and a second ratio is defined between the second pyramidal angle of the first workpiece and the other of the first pyramidal angle and second pyramidal angle of the second workpiece, and each of the first ratio and the second ratio is a function of a third ratio between the first strength parameter and the second strength parameter.

As described above, the selection of the first and second pyramidal angles assists in the ejection of surface contaminants from the weld zone in the flash. However, when the first workpiece and the second workpiece are formed from different materials it may be necessary to provide the first workpiece with different first and second pyramidal angles to those on the second workpiece in order to ensure that the resulting friction weld is fully formed across the weld zone.

Consequently, it may be necessary to adjust the first and second workpiece geometry such that a ratio between the first and second pyramidal angles on the first workpiece, and the corresponding first and second pyramidal angles on the second workpiece, corresponds to a ratio between a strength parameter of the first and second workpiece materials.

Optionally, the first workpiece is formed from a first material having a first strength parameter, and the second workpiece is formed from a material having a second strength parameter, and a first ratio is defined between the third pyramidal angle of the first workpiece and a corresponding one of the third pyramidal angle and fourth pyramidal angle of the second workpiece, and a second ratio is defined between the fourth pyramidal angle of the first workpiece and the other of the third pyramidal angle and fourth pyramidal angle of the second workpiece, and each of the first ratio and the second ratio is a function of a third ratio between the first strength parameter and the second strength parameter.

As outlined above, the third pyramidal angle and the fourth pyramidal angle provide the outer edge regions of the workpiece with increased mechanical support and thus reduces the possibility of deformation or detachment of the workpiece corners.

In a situation where the first workpiece and the second workpiece are formed from dissimilar materials, the material characteristics for the first workpiece will differ from the material characteristics for the second workpiece. This difference in material characteristics between the first workpiece and the second workpiece will result in an asymmetric upsetting behaviour during the friction welding process between the first workpiece and the second workpiece. If both the first workpiece and the second workpiece have the same geometry then the resulting friction weld will be asymmetric across the weld interface, for example with a harder workpiece ‘burrowing’ into a softer workpiece and so producing a poor quality welded joint.

It is therefore necessary to adjust the first and second workpiece geometry such that a ratio between the third and fourth pyramidal angles on the first workpiece, and the corresponding third and fourth pyramidal angles on the second workpiece, corresponds to a ratio between a strength parameter of the first and second workpiece materials.

In one arrangement, the ratio between the third and fourth pyramidal angles on the first workpiece, and the respective third and fourth pyramidal angles on the second workpiece may be determined on the basis of the relative upset of each of the first and second workpieces when the first workpiece and the second workpiece have the same geometry.

Optionally, the strength parameter is selected from the group consisting of flow stress, yield stress and ultimate tensile stress.

As outlined above, empirical relative upset data may be used to determine the ratio between the third and fourth pyramidal angles on the first workpiece, and the respective third and fourth pyramidal angles on the second workpiece. Alternatively, this ratio may be determined using an analytical modelling technique. Such techniques use the material parameters such as flow stress, yield stress or ultimate tensile stress to model the flow behaviour of the material during the friction welding process.

Optionally, the step of providing a first workpiece and a second workpiece, the first workpiece comprising a first weld surface, and the second workpiece comprising a second weld surface, and at least one of the first workpiece and the second workpiece comprising a workpiece according to the first aspect, comprises the step of:
providing a first workpiece and a second workpiece, the first workpiece comprising a first weld surface, and the second workpiece comprising a second weld surface, the first workpiece comprising a workpiece according to the first aspect, and the second weld surface comprising a central surface being flanked on either side respectively by a first flank surface and a second flank surface, the first flank surface subtending a first flank angle with the central surface, the second flank surface subtending a second flank angle with the central surface, and each of the first flank angle and the second flank angle being less than 90°.

In this arrangement, the first workpiece has a double pyramidal workpiece geometry as detailed above, and the second workpiece has planar central surface flanked on either side respectively by first and second flank surfaces.

In the same way as outlined above for the double pyramidal geometry, the first and second flank surfaces provide the outer edge regions of the second workpiece with increased mechanical support and thus reduces the possibility of deformation or detachment of the second workpiece corners.

According to a third aspect of the present disclosure there is provided a pair of friction welding workpieces for use with a friction welding process, comprising a first workpiece and a second workpiece, wherein the first workpiece comprises a first weld surface and the second workpiece comprises a second weld surface, the first weld surface comprising a central ridge surface extending along the weld surface, the central ridge surface being flanked on either side respectively by a first pyramidal surface and a second pyramidal surface, the first pyramidal surface subtending a first pyramidal angle with the central ridge surface, and the second pyramidal surface subtending a second pyramidal angle with the central ridge surface, the first pyramidal surface being further flanked by a first side surface, and the second pyramidal surface being further flanked by a second side surface, each of the first and second side surfaces being normal to the central ridge surface, the second weld surface comprising a central surface being flanked on either side respectively by a first flank surface and a second flank surface, the first flank surface subtending a first flank angle with the central surface, the second flank surface subtending a second flank angle with the central surface, and each of the first flank angle and the second flank angle being less than 90°, and the first weld surface is positioned in conformal engagement with the second weld surface.

In this arrangement, the first workpiece and the second workpiece may each be formed from the same material. There may be design limitations on a lateral width of the first workpiece that prevents the geometry of the first workpiece from including third and fourth pyramidal surfaces. In other words, the first workpiece is provided with first and second side surfaces that are normal to the central ridge surface. In this arrangement, the second workpiece may be provided with angled first and second flank surfaces. These first and second flank surfaces act to provide additional lateral support to the edges of the weld interface. In this way, the first and second flank surfaces act to prevent deformation and detachment at the edges of the weld interface.

Optionally, the central ridge surface has a lateral width of between approximately 1 mm and 5 mm.

Keeping the lateral width of the central ridge less than 5 mm more effectively provides for the ejection of surface contaminants from the weld zone.

Optionally, each of the first pyramidal angle and the second pyramidal angle is between approximately 6° and 30°.

Keeping the first pyramidal angle and the second pyramidal angle within the range of approximately 6° and 30° provides a balance between ensuring the elimination of surface contaminants from the weld zone, and minimising the volume of material that must be ejected from the joint as flash during the weld process.

Optionally, the reciprocating motion is a linear reciprocating motion.

In one arrangement the relative motion between the first workpiece and the second workpiece is a linear reciprocating motion.

In other arrangements, the relative motion between the first workpiece and the second workpiece is nonlinear, such as a sinusoidal reciprocating motion or an elliptical reciprocating motion.

Optionally, the weld surface is curvilinear.

Optionally, each of the first workpiece and the second workpiece is formed from a titanium alloy.

Optionally, the first workpiece is a rotor, and the second workpiece is a rotor blade.

Optionally, the rotor is a fan disc, and the blade is a fan blade.

Optionally, the rotor is a compressor disc or a compressor drum, and the blade is a compressor blade.

According to a fourth aspect of the present disclosure there is provided a computer program that, when read by a computer, causes performance of the method according to the second aspect of the present disclosure.

According to a fifth aspect of the present disclosure there is provided a non-transitory computer readable storage medium comprising computer readable instructions that, when read by a computer, cause performance of the method according to the second aspect of the present disclosure.

According to a sixth aspect of the present disclosure there is provided a signal comprising computer readable instructions that, when read by a computer, cause performance of the method according to the second aspect of the present disclosure.

Other aspects of the disclosure provide devices, methods and systems which include and/or implement some or all of the actions described herein. The illustrative aspects of the disclosure are designed to solve one or more of the problems herein described and/or one or more other problems not discussed.

### BRIEF DESCRIPTION OF THE DRAWINGS

There now follows a description of an embodiment of the disclosure, by way of non-limiting example, with reference being made to the accompanying drawings in which:

FIG. 1 shows a schematic sectional view of a linear friction welded joint according to the prior art;

FIGS. 2A, 2B and 2C shows schematic views of a linear friction welded joint, according to the prior art, in which one stub portion has a single pyramidal geometry, and illustrating the problem of deformation and detachment of the joint corners;

FIG. 3 shows a schematic perspective view of a weld stub according to a first embodiment of the present disclosure;

FIG. 4 shows a sectional view on the weld stub of FIG. 3;

FIG. 5 shows a schematic perspective view of two opposing weld stubs, each according to a first embodiment of the present disclosure, and illustrating the orientation of axial and lateral motion;

FIG. 6 shows the two opposing weld stubs of FIG. 5 in contact with one another;

FIG. 7 shows a schematic perspective view of a rotor and a rotor blade embodying a weld stub according to the disclosure of FIGS. 3 to 6;

FIG. 8 shows a schematic sectional view of two opposing weld stubs, each according to a second embodiment of the present disclosure;

FIG. 9 shows a schematic sectional view of two opposing weld stubs, each according to a third embodiment of the present disclosure;

FIG. 10 shows a schematic sectional view of two opposing weld stubs, each according to a fourth embodiment of the present disclosure; and

FIG. 11 shows a schematic sectional view of two opposing weld stubs, each according to a fifth embodiment of the present disclosure.

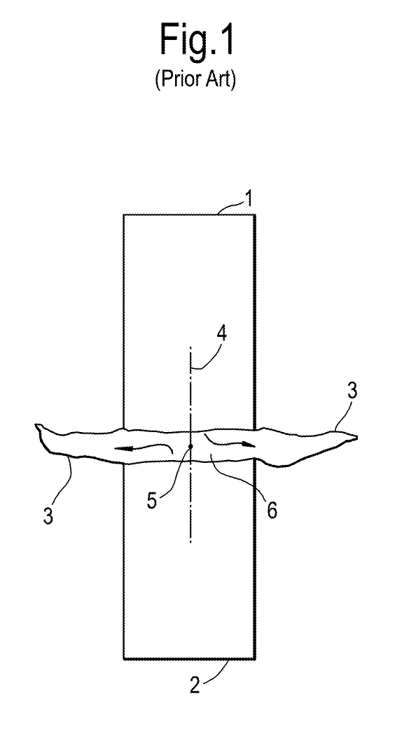

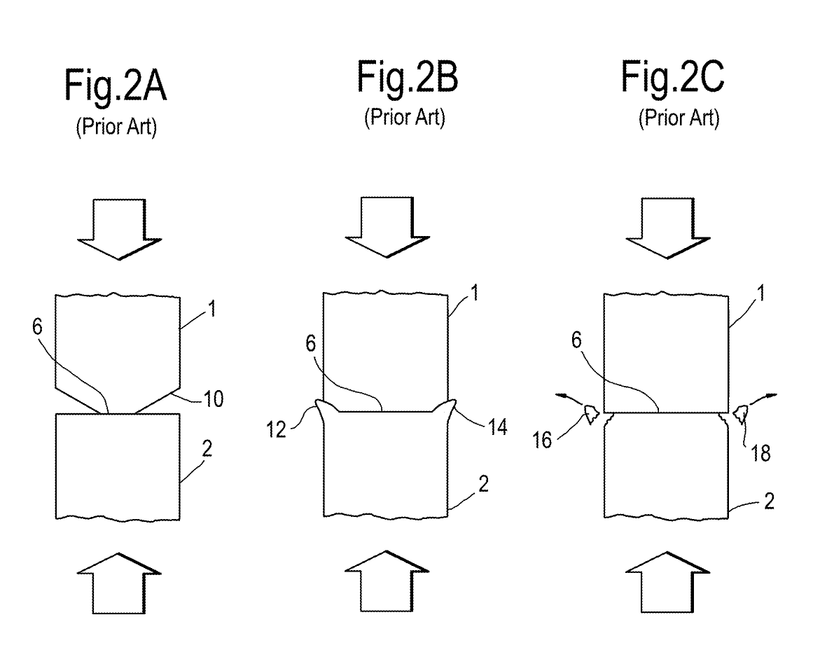

It is noted that the drawings may not be to scale. The drawings are intended to depict only typical aspects of the disclosure, and therefore should not be considered as limiting the scope of the disclosure. In the drawings, like numbering represents like elements between the drawings.

### DETAILED DESCRIPTION

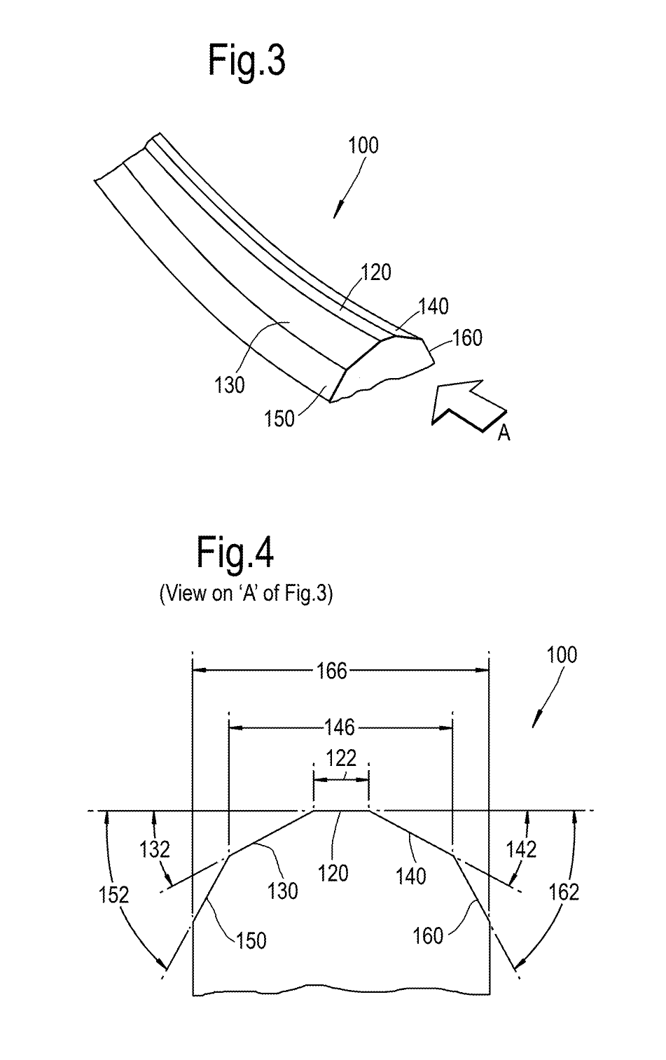

Referring to FIGS. 3 to 5, a workpiece for use with a friction welding process, according to a first embodiment of the disclosure is designated generally by the reference numeral 100.

The workpiece 100 takes the form of a weld stub 100 and comprises a weld surface 110. The weld surface 110 comprises a central ridge surface 120 extending along the weld surface 110. The central ridge surface 120 extends linearly across a lateral width 122 of the weld surface 110. In the illustrated embodiment the central ridge surface 120 has a lateral width 122 of 4 mm. The central ridge surface 120 is flanked on either side respectively by a first pyramidal surface 130 and a second pyramidal surface 140.

The first pyramidal surface 130 subtends a first pyramidal angle 132 with the central ridge surface 120. The second pyramidal surface 140 subtends a second pyramidal angle 142 with the central ridge surface 120. The first and second pyramidal surfaces 130,140 together with the central ridge surface 120 together define an upper pyramidal width 146, which in this embodiment has a value of 8 mm.

The first pyramidal surface 130 is further flanked by a third pyramidal surface 150 on a distal side of the first pyramidal surface 130 from the central ridge surface 120. The second pyramidal surface 140 is further flanked by a fourth pyramidal surface 160 on a distal side of the second pyramidal surface 140 from the central ridge surface 120. The third and fourth pyramidal surfaces 150,160 together with the central ridge surface 120 together define a lower pyramidal width 166, which in this embodiment has a value of 14 mm.

The third pyramidal surface 150 subtends a third pyramidal angle 152 with the central ridge surface 120. The fourth pyramidal surface 160 subtends a fourth pyramidal angle 162 with the central ridge surface 120.

This arrangement of a central ridge surface 120 flanked on opposing sides by first and second pyramidal surfaces 130,140 that are in turn flanked on opposing sides by third and fourth pyramidal surfaces 150,160 provides a double pyramidal sectional geometry to the workpiece 100.

In the arrangement shown in FIGS. 3 to 5, the first pyramidal angle 132 is equal to the second pyramidal angle 142. In this arrangement, the first and second pyramidal angles 132,142 are each acute angles and have a value of between 8° and 12° relative to the central ridge surface 120.

In the arrangement shown in FIGS. 3 to 5, the third pyramidal angle 152 is equal to the fourth pyramidal angle 142. In this arrangement, the third and fourth pyramidal angles 142,152 are each acute angles and have a value of between 30° and 65° relative to the central ridge surface 120.

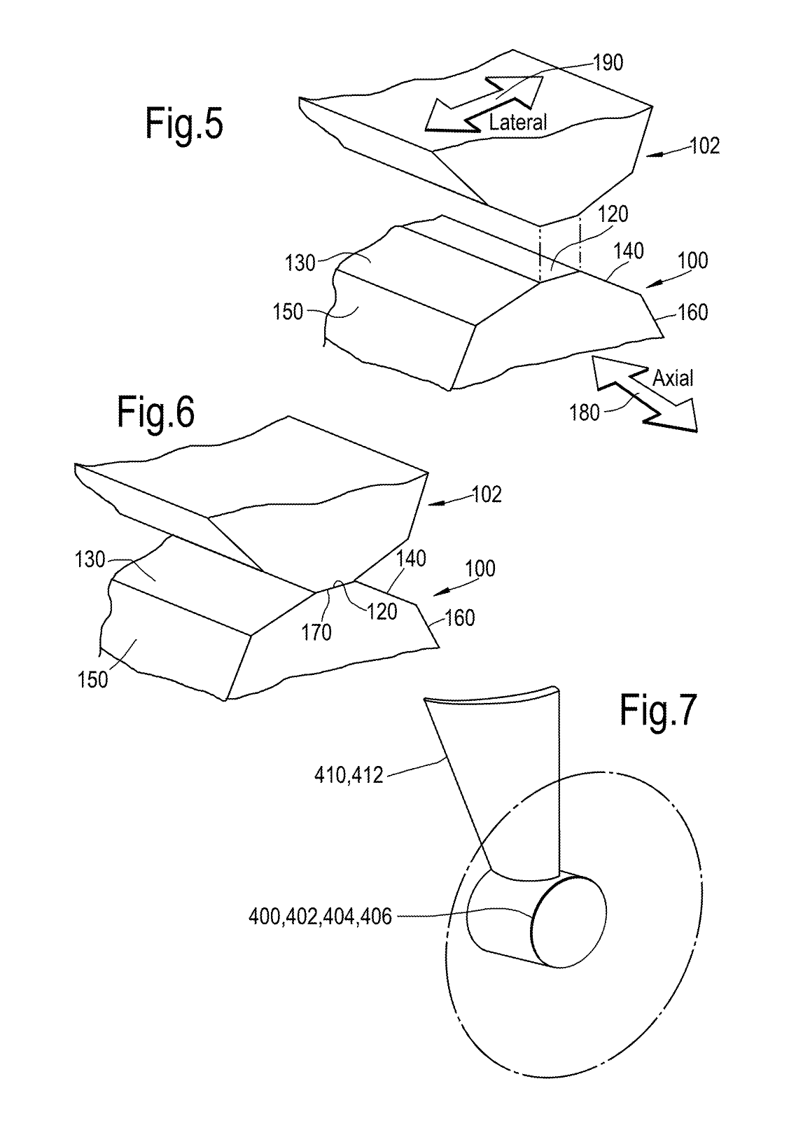

FIG. 5 shows a schematic perspective view of a weld joint comprising a first workpiece 100 and a second workpiece 102. In this arrangement, each of the first workpiece 100 and the second workpiece 102 comprises the features described above in relation to the workpiece 100 shown in FIGS. 3 and 4.

The first workpiece 100 and the second workpiece 102 are brought together such that the central ridge surface 120 of each workpiece 100,102 are aligned and in contact with one another, defining a weld interface 170.

A linear friction welding process is then initiated by applying a compressive force normally across the contact between the central ridge surfaces 120 of each of the first and second workpieces 100,102, whilst also providing relative reciprocating motion between the first and second workpieces 100,102. This follows conventional linear friction welding process operation and the details of this operation will not be discussed further here, being well known to a skilled person.

In the arrangement illustrated in the figures, the reciprocating motion is in the lateral direction as indicated by feature 190 in FIG. 5.

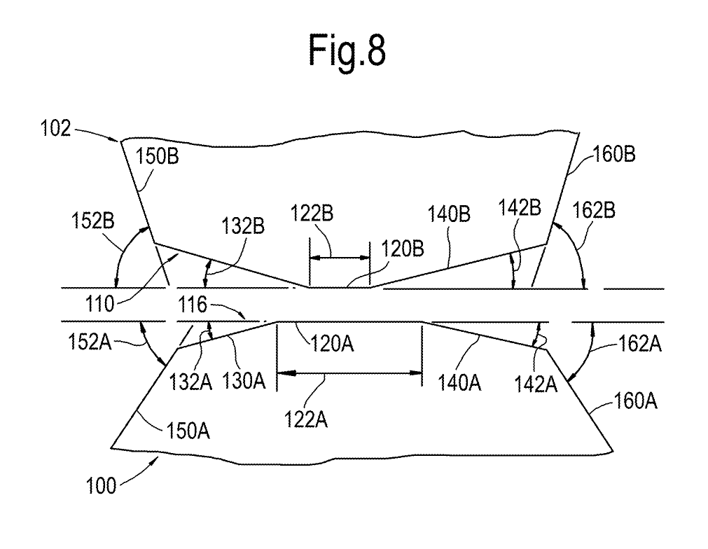

A workpiece according to a second embodiment of the disclosure is illustrated in FIG. 8. In this arrangement, the first workpiece 100 is formed from a first material having a first hardness value, and the second workpiece 102 is formed from a second material having a second hardness value, where the first hardness is less than the second hardness. For example, the first workpiece 100 may be formed from a first titanium alloy and the second workpiece 102 may be formed from a second titanium alloy, where the first titanium alloy has a higher hardness than the second titanium alloy.

Both the first workpiece 100 and the second workpiece 102 have a double pyramidal sectional geometry as outlined above in relation to the first embodiment of the disclosure.

Each of the first workpiece 100 and the second workpiece 102 comprises a central ridge surface 120A,120B having a lateral width 122A,122B that is flanked on either side respectively by a first pyramidal surface 130A,130B and a second pyramidal surface 140A,140B. In this embodiment the central ridge surface 120A has a lateral width 122A of 4 mm, and the central ridge surface 120B has a lateral width 122B of 2 mm.

The first pyramidal surface 130A,130B subtends a first pyramidal angle 132A,132B with the central ridge surface 120A,120B. The second pyramidal surface 140A,140B subtends a second pyramidal angle 142A,142B with the central ridge surface 120A,120B. In this embodiment the first pyramidal angle 132A is equal to the first pyramidal angle 132B and, in turn, is equal to each of the second pyramidal angles 142A,142B. In this embodiment, the first and second pyramidal angles 132A,132B;142A,142B subtend an angle of 14° relative to the respective central ridge surface 120A,120B.

Each first pyramidal surface 130A,130B is further flanked by a third pyramidal surface 150A,150B on a distal side of the first pyramidal surface 130A,130B from the central ridge surface 120A,120B. Each second pyramidal surface 140A,140B is further flanked by a fourth pyramidal surface 160A,160B on a distal side of the second pyramidal surface 140A,140B from the central ridge surface 120A,120B.

The third pyramidal surface 150A,150B subtends a third pyramidal angle 152A,152B with the central ridge surface 120A,120B. The fourth pyramidal surface 160A,160B subtends a fourth pyramidal angle 162A,162B with the central ridge surface 120A,120B.

In this embodiment, the third pyramidal angle 152A is equal to the fourth pyramidal angle 162A, and each subtends an angle of 40° relative to the central ridge surface 120A. Additionally, the third pyramidal angle 152B is equal to the fourth pyramidal angle 162B, and each subtends an angle of 70° relative to the central ridge surface 120B.

The higher hardness of the second workpiece 102 relative to that of the first workpiece 100 means that the third and fourth pyramidal angles 152B,162B of the second workpiece 102 can be greater than the corresponding third and fourth pyramidal angles 152A,162A of the first workpiece 100. This is because the higher hardness of the second workpiece 102 requires less mechanical support to prevent deformation or detachment of the sub corners.

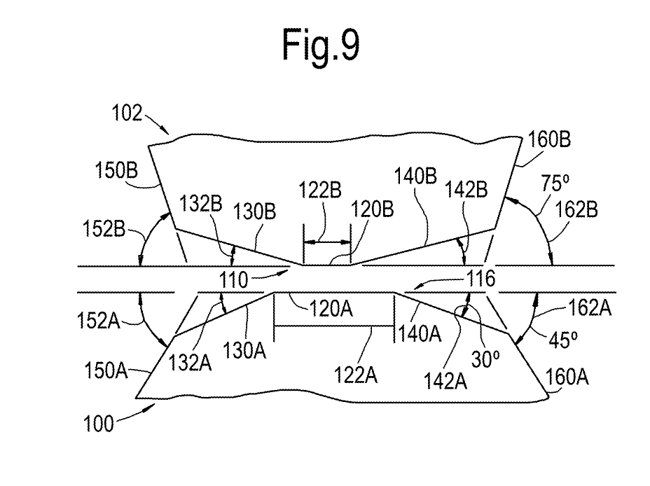

FIG. 9 illustrates a third embodiment of the workpiece of the present disclosure. The workpiece of FIG. 9 has the same double pyramidal cross-sectional geometry as has been described above in relation to the second embodiment of the workpiece.

The embodiment of FIG. 9 differs from the embodiment of FIG. 8 only in respect of the first and second pyramidal angles 132A,142A. In the embodiment of FIG. 9, the first pyramidal angle 132A is equal to the second pyramidal angle 142A, and each subtends an angle of 25° relative to the central ridge surface 120A.

As explained previously, the third and fourth pyramidal surfaces (150A,150B;160A,160B) prevent the generation of material deformation and detachment at the weld interface by providing additional lateral support to the edges of the weld interface. This additional mechanical support prevents the material ejected from the weld interface from deforming and detaching from the weld stub.

Since the first and second materials have different hardness values to one another it is necessary to provide the first workpiece 100 with a different value for the third and fourth pyramidal angle to that of the second workpiece 102.

The determination of the third and fourth pyramidal angles 152A,152B;162A,162B for each of the first and second workpieces 100,102 can be determined from the relative upset between the first and second workpieces 100,102. In other words, by knowing the upset behaviour of each of the first and second materials, for example for a standard geometry it is possible to determine the magnitudes the third and fourth pyramidal angles 152A,152B;162A,162B for each of the first and second workpieces 100,102.

As an example, if the first workpiece 100 is formed from a harder material than the second workpiece 102, then the third and fourth pyramidal angles 152A;162A for the first workpiece 100 will be greater (i.e. closer to 90°) than the corresponding third and fourth pyramidal angles 152B; 162B for the second workpiece 102.

While the second and third embodiments (illustrated in FIGS. 8 and 9) relate to situations in which the first and second workpiece 100,102 are formed from materials having different hardness, the workpiece geometry of the present disclosure may equally be applied to situations in which the first workpiece 100 and the second workpiece 102 are formed from materials having the same hardness. For example, the first workpiece and the second workpiece may each be formed from a titanium alloy.

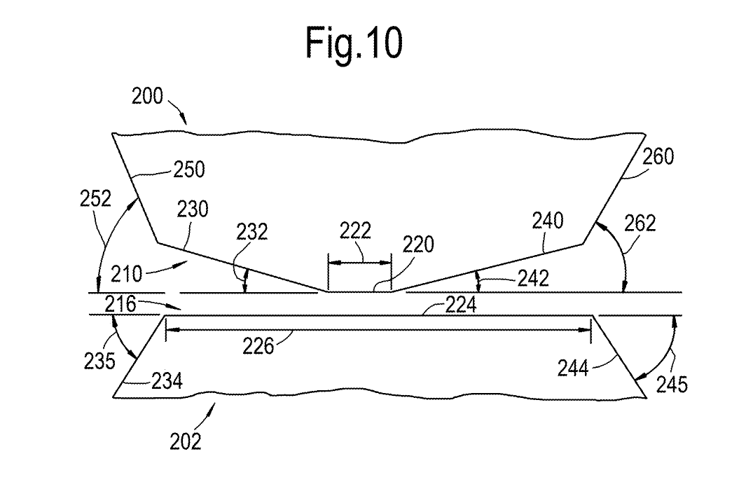

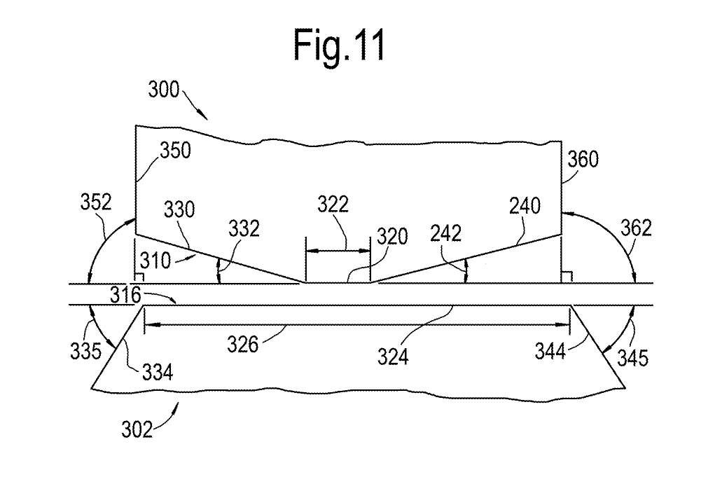

FIGS. 10 and 11 respectively show fourth and fifth embodiments of the present disclosure in which the first workpiece 200,300 and the second workpiece 202,302 are formed from materials having the same hardness.

FIG. 10 illustrates a fourth embodiment of the present disclosure, in which a first workpiece 200 is formed from a first material, and a second workpiece 201 is formed from a second material, with the first and second materials having the same hardness.

The first workpiece 200 comprises a central ridge surface 220 having a lateral width 222 that is flanked on either side by a first pyramidal surface 230 and a second pyramidal surface 240. The first pyramidal surface 230 subtends a first pyramidal angle 232 with the central ridge surface 220, and the second pyramidal surface 240 subtends a second pyramidal angle 242 with the central ridge surface 220. In this embodiment, each of the first pyramidal angle 232 and the second pyramidal angle 242 is 10°.

The first pyramidal surface 230 is further flanked by a third pyramidal surface 250 on a distal side of the first pyramidal surface 230 from the central ridge surface 220. The second pyramidal surface 240 is further flanked by a fourth pyramidal surface 260 on a distal side of the second pyramidal surface 240 from the central ridge surface 220.

The third pyramidal surface 250 subtends a third pyramidal angle 252 with the central ridge surface 220. The fourth pyramidal surface 260 subtends a fourth pyramidal angle 262 with the central ridge surface 220. In this embodiment, the third pyramidal angle 252 is equal to the fourth pyramidal angle 262, and each subtends an angle of 40° relative to the central ridge surface 220.

The second workpiece 202 comprises a central surface 224 having a lateral width 226 of approximately 24 mm, flanked on either side respectively by a first flank surface 234 and a second flank surface 236. Each of the first flank surface 234 and the second flank surface 244 subtends a corresponding first flank angle 235 and second flank angle 245 relative to the central surface 224. In this arrangement, the first flank angle 234 is equal to the second flank angle 245 and has a value of 40°.

FIG. 11 illustrates a fifth embodiment of the present disclosure, in which a first workpiece 300 is formed from a first material, and a second workpiece 301 is formed from a second material, with the first and second materials having the same hardness.

The first workpiece 300 comprises a central ridge surface 320 having a lateral width 322 that is flanked on either side by a first pyramidal surface 330 and a second pyramidal surface 340. The first pyramidal surface 330 subtends a first pyramidal angle 332 with the central ridge surface 320, and the second pyramidal surface 340 subtends a second pyramidal angle 342 with the central ridge surface 320. In this embodiment, each of the first pyramidal angle 332 and the second pyramidal angle 342 is 10°.

The first pyramidal surface 330 is further flanked by a first side surface 350 on a distal side of the first pyramidal surface 330 from the central ridge surface 320. The second pyramidal surface 340 is further flanked by a second surface 360 on a distal side of the second pyramidal surface 340 from the central ridge surface 320.

Each of the first side surface 350 and the second side surface 360 is oriented at 90° to (i.e. normal to) the central ridge surface 320.

The second workpiece 302 comprises a central surface 324 having a lateral width 326 of approximately 24 mm, flanked on either side respectively by a first flank surface 334 and a second flank surface 336. Each of the first flank surface 334 and the second flank surface 344 subtends a corresponding first flank angle 335 and second flank angle 345 relative to the central surface 324. In this arrangement, the first flank angle 334 is equal to the second flank angle 345 and has a value of 40°.

The workpieces and the method of the disclosure may be applied to a variety of linear friction welding scenarios. FIG. 7 illustrates an example of such an application in which a rotor 400 is joined with a rotor blade 410. A plurality of fan rotor blades 410 may then be joined to the rotor 400 to thereby form a bladed fan disk 402. In the alternative, a plurality of compressor blades 412 may be joined to a compressor drum 406 to form a compressor disk 404.

Except where mutually exclusive, any of the features may be employed separately or in combination with any other features and the disclosure extends to and includes all combinations and sub-combinations of one or more features described herein.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person of skill in the art are included within the scope of the disclosure as defined by the accompanying claims.

1-9. (canceled)

10. A method of linear friction welding, the method comprising:
positioning a first workpiece adjacent to a second workpiece with a first weld surface of the first workpiece being in engagement with a second weld surface of the second workpiece, and wherein the first weld surface comprises central ridge surface extending along the first weld surface, wherein the central ridge surface is flanked on either side respectively by a first pyramidal surface and a second pyramidal surface, the first pyramidal surface subtending a first pyramidal angle with the central ridge surface, and the second pyramidal surface subtending a second pyramidal angle with the central ridge surface, the first pyramidal surface being further flanked by a third pyramidal surface, and the second pyramidal surface being further flanked by a fourth pyramidal surface, the third pyramidal surface subtending a third pyramidal angle with the central ridge surface, the fourth pyramidal surface subtending a fourth pyramidal angle with the central ridge surface, and wherein each of the third pyramidal angle and the fourth pyramidal angle is less than 90°;
reciprocating the first workpiece and the second workpiece against one another such that at least one of the first weld surface and the second weld surface moves relative to the other of the first weld surface and the second weld surface, such that a temperature at the first and second weld surfaces increases to create a weld interface; and
stopping the reciprocating and allowing the first workpiece and the second workpiece to cool to weld the first workpiece and the second workpiece together.

11. The method as claimed in claim 10, wherein
the second weld surface comprises second central ridge surface extending along the second weld surface, wherein the second central ridge surface is flanked on either side respectively by a fifth pyramidal surface and a sixth pyramidal surface, the fifth pyramidal surface subtending a fifth pyramidal angle with the second central ridge surface, and the sixth pyramidal surface subtending a sixth pyramidal angle with the second central ridge surface, the fifth pyramidal surface being further flanked by a seventh pyramidal surface, and the sixth pyramidal surface being further flanked by an eighth pyramidal surface, the seventh pyramidal surface subtending a seventh pyramidal angle with the second central ridge surface, the eighth pyramidal surface subtending an eighth pyramidal angle with the second central ridge surface, and wherein each of the seventh pyramidal angle and the eighth pyramidal angle is less than 90°.

12. The method as claimed in claim 10, wherein the first workpiece is formed from a first material having a first strength parameter, and the second workpiece is formed from a material having a second strength parameter, and a first ratio is defined between the first pyramidal angle of the first workpiece and a corresponding one of the fifth pyramidal angle and sixth pyramidal angle of the second workpiece, and a second ratio is defined between the second pyramidal angle of the first workpiece and the other of the fifth pyramidal angle and sixth pyramidal angle of the second workpiece, and each of the first ratio and the second ratio is a function of a third ratio between the first strength parameter and the second strength parameter.

13. The method as claimed in claim 10, wherein the first workpiece is formed from a first material having a first strength parameter, and the second workpiece is formed from a material having a second strength parameter, and a first ratio is defined between the third pyramidal angle of the first workpiece and a corresponding one of the seventh pyramidal angle and eighth pyramidal angle of the second workpiece, and a second ratio is defined between the fourth pyramidal angle of the first workpiece and the other of the seventh pyramidal angle and eighth pyramidal angle of the second workpiece, and each of the first ratio and the second ratio is a function of a third ratio between the first strength parameter and the second strength parameter.

14. The method as claimed in claim 12, wherein the strength parameter is selected from the group consisting of flow stress, yield stress and ultimate tensile stress.

15. The method as claimed in claim 4, wherein the strength parameter is selected from the group consisting of flow stress, yield stress and ultimate tensile stress.

16. The method as claimed in claim 10, wherein
the second weld surface comprises a central surface being flanked on either side respectively by a first flank surface and a second flank surface, the first flank surface subtending a first flank angle with the central surface, the second flank surface subtending a second flank angle with the central surface, and each of the first flank angle and the second flank angle being less than 90°.

17-19. (canceled)

20. The method as claimed in claim 10, wherein the first pyramidal angle is equal to the second pyramidal angle.

21. The method as claimed in claim 10, wherein the third pyramidal angle is equal to the fourth pyramidal angle.

22. The method as claimed in claim 10, wherein the central ridge surface has a lateral width of between approximately 1 mm and 5 mm.

23. The method as claimed in claim 10, wherein each of the first pyramidal angle and the second pyramidal angle is between approximately 6° and approximately 12°.

24. The method as claimed in claim 10, wherein each of the first pyramidal angle and the second pyramidal angle is between approximately 6° and approximately 30°.

25. The method as claimed in claim 10, wherein each of the third pyramidal angle and the fourth pyramidal angle is between approximately 30° and approximately 65°.

26. The method as claimed in claim 10, wherein each of the third pyramidal angle and the fourth pyramidal angle is between approximately 30° and approximately 90°.

27. The method as claimed in claim 10, wherein at least one of the first workpiece or the second workpiece is formed from a titanium alloy or a nickel alloy.
